(19) United States
(12) Patent Application Publication
(10) Pub. No.: US 2016/0215964 A1
(43) Pub. Date: Jul. 28, 2016

(54) Customizable Stand Lamp

(71) Applicant: Feit Electric Company, Inc., Pico Rivera, CA (US)

(72) Inventor: Alan Barry Feit, Encino, CA (US)

(21) Appl. No.: 15/006,396

(22) Filed: Jan. 26, 2016

Related U.S. Application Data
(60) Provisional application No. 62/107,736, filed on Jan. 26, 2015.

(51) Int. Cl. F21V 21/14; F21S 6/00

(52) U.S. Cl. CPC F21V 21/14; F21S 6/002; F21S 6/004

(57) ABSTRACT

Various embodiments are directed to an infinitely flexible stand lamp having a replaceable lamp assembly configured to enable a user to replace and/or interchange the lamp assembly with alternative lamp assemblies. In various embodiments, the stand lamp comprises a base, an infinitely flexible support arm coupled to the base and defining an arm connection point, and a removable lamp assembly comprising one or more light emitters (e.g., light emitting diodes) and a housing, wherein the removable lamp assembly defines a housing connection point. The housing connection point and the arm connection point are configured to be detachably coupled to form an electrical connection therebetween.

### CROSS-REFERENCE TO RELATED APPLICATIONS

This patent application claims priority to Provisional Application Ser. No. 62/107,736, filed Jan. 26, 2015 and entitled “Customizable Stand Lamp,” which is incorporated herein by reference in its entirety.

### BACKGROUND

Floor and table stand lamps are often designed and utilized for a singular purpose. Various existing floor and table stand lamps include features specifically designed for certain purposes. For example, certain floor lamps include lamps and associated shades specifically configured for directing light downward onto the pages of an open book being read by a user in a nearby chair. As yet another example, certain table lamps include lamp shades configured to diffuse light.

However, because stand lamps historically have included various features specifically designed for certain uses, these stand lamps are generally unsuitable for other uses. Therefore, a need exists for a customizable stand lamp having reconfigurable features suitable for a plurality of uses.

### BRIEF SUMMARY

Various embodiments provide a customizable stand lamp having a plurality interchangeable lamp heads each configured to provide a different style and/or type of light. Each of the interchangeable lamp heads may be configured to be secured to a common base assembly via a common attachment mechanism that provides both structural support and electrical connectivity between the attached interchangeable head and the base assembly.

Various embodiments are directed to a stand lamp comprising a base; an infinitely flexible support arm coupled to the base and defining an arm connection point; and a removable lamp assembly comprising one or more light emitters (e.g., one or more light emitting diodes) and a housing, wherein the removable lamp assembly defines a housing connection point. In various embodiments, the housing connection point and the arm connection point are configured to be detachably coupled together to form an electrical connection therebetween. In various embodiments, the infinitely flexible support arm may be sized such that the stand lamp is a floor lamp or a table lamp. Moreover, various embodiments may additionally comprise a user interface, such as a power control a dimmer, a touch-sensitive switch, and/or the like.

In various embodiments, the housing may comprise a lamp shade and/or a diffuser. Moreover, in various embodiments, the stand lamp further comprises a second removable lamp assembly, the second removable lamp assembly comprising one or more light emitters, a second housing, and a second housing connection point, wherein the second housing connection point is configured to be coupled to the arm connection point to form an electrical connection therebetween.

Moreover, in various embodiments, the support arm defines a hollow conduit therein, and wherein the stand lamp additionally comprises a conductor positioned within the hollow conduit of the support arm electrically connecting the base and the arm connection point. In various embodiments, the arm connection point and the housing connection point define corresponding threads configured to interlock to detachably secure the arm connection point and the housing connection point. In yet other embodiments, the arm connection point and the housing connection point may be configured to be frictionally engaged to detachably secure the arm connection point and the housing connection point.

### BRIEF DESCRIPTION OF THE SEVERAL VIEWS OF THE DRAWINGS

Reference will now be made to the accompanying drawings, which are not necessarily drawn to scale, and wherein:

FIGS. 1A-1B provide views of a stand lamp having a first removable lamp assembly configuration according to various embodiments of the present invention;

FIGS. 2A-2C provide views of a stand lamp having a second removable lamp assembly configuration according to various embodiments of the present invention;

FIGS. 3A-3C provide views of a stand lamp having a third removable lamp assembly configuration according to various embodiments of the present invention;

FIGS. 4A-4C provide views of a stand lamp having a fourth removable lamp assembly configuration according to various embodiments of the present invention;

FIGS. 5A-5C provide views of a stand lamp having a fifth removable lamp assembly configuration according to various embodiments of the present invention;

FIG. 6 illustrates an example range of motion of a support arm according to various embodiments of the present invention;

FIGS. 7A-7F provide views of various stand lamp features that may be incorporated into the stand lamp according to various embodiments; and

FIG. 8 shows a close-up view of a detachable joint according to various embodiments of the present invention.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

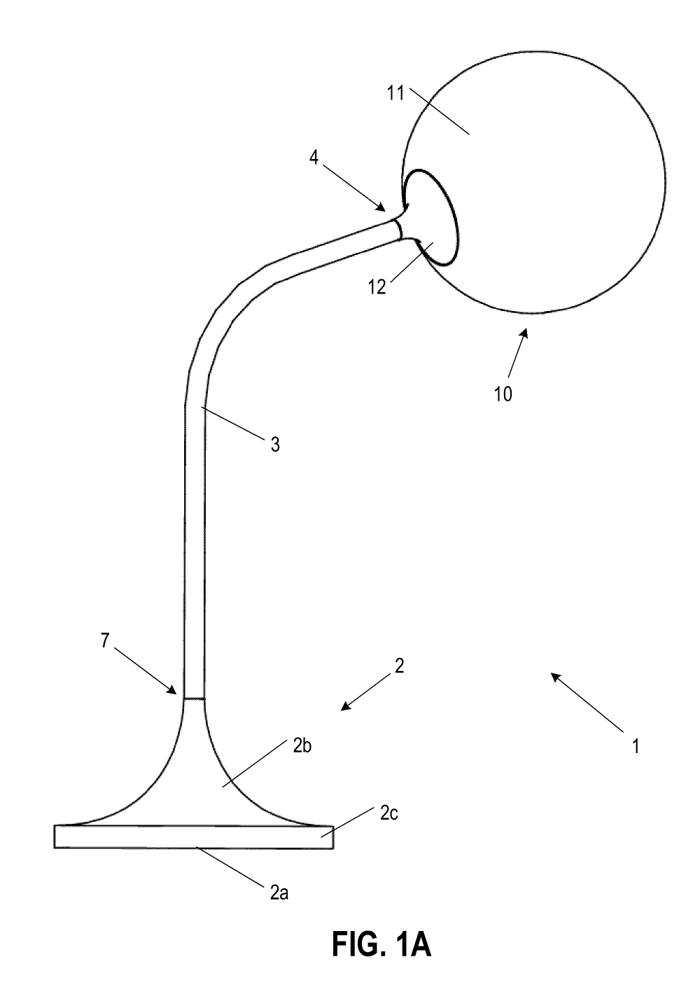

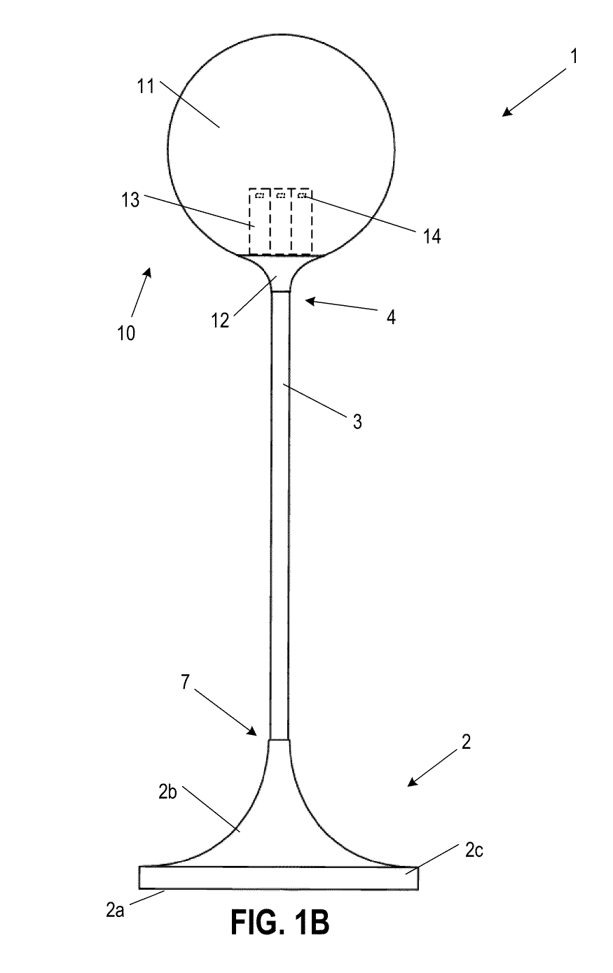

Referring now to FIGS. 1A-1B, which show a perspective view and side view, respectively, of a stand lamp 1 according to various embodiments, the stand lamp 1 may comprise a base 2, a support arm 3, and a removable lamp assembly 10. In various embodiments, the base 1 may comprise a plastic or metal material, and may comprise one or more internal components (not shown). For example, the base 2 may comprise a weight configured to provide support for the stand lamp 1 (e.g., an iron block). As yet additional non-limiting examples, the base may comprise a power source (e.g., a battery), control circuitry, and/or the like.

As shown in FIGS. 1A-1B, the base 2 may comprise a planar bottom surface 2a configured to rest on a horizontal support surface, an upper surface 2b generally opposite the bottom surface, and one or more at least substantially vertical sides 2c. As shown in FIG. 1, the upper surface 2b may comprise one or more simple or complex curve features that may slope from a generally horizontal portion proximate the one or more sides 2c to a generally vertical portion located proximate the center of the upper surface 2b. However, such illustrated configuration is merely one example of a plurality of base configurations. For example, the base 2 may be cube-shaped, cylinder-shaped, pyramid-shaped, and/or the like. Accordingly, in various embodiments, the base 2 may not comprise separate vertical sides 2c, and instead the top portion 2b may meet the horizontal base 2a at a corner. Moreover, although not shown, the base may comprise one or more mounting mechanisms configured to secure the stand lamp 1 to a vertical or horizontal surface. For example, the mounting mechanisms may comprise one or more fastener holes configured to accept a fastener (e.g., screw holes, nail holes, and/or the like) therein, hook-and-loop fasteners, peg-board style hook fasteners, magnets, and/or the like. Moreover, although the base 2 is illustrated as generally circular, the base may comprise any of a variety of shapes (e.g., triangular, rectangular, and/or the like).

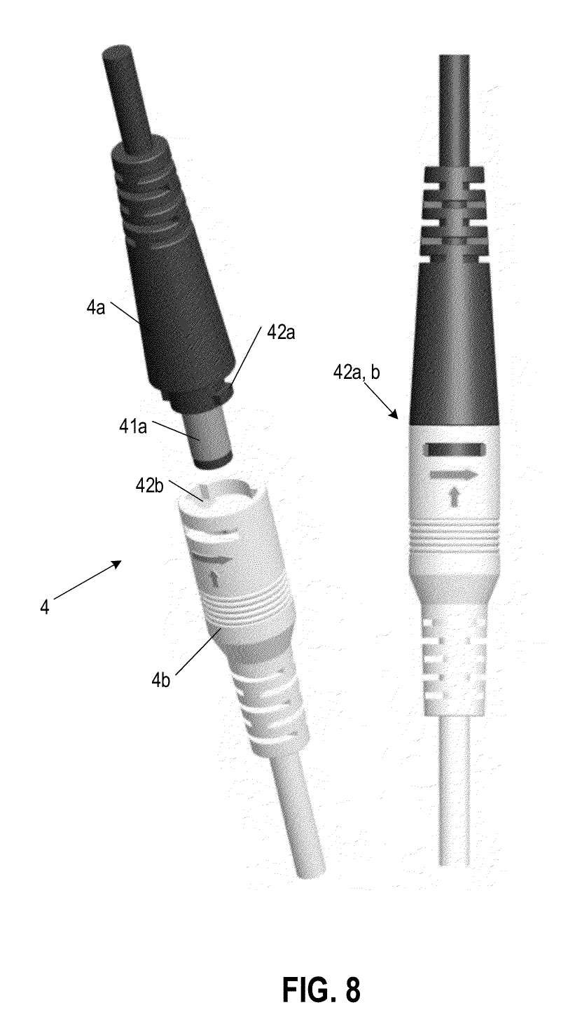

Referring again to FIGS. 1A-1B, the base 2 may be configured to be secured to a support arm 3 via a base joint 7. As shown in FIGS. 1A-1B, the support arm 3 may be coupled to the upper surface 2b of the base 2 at the joint 7. In various embodiments, the base joint 7 at which the support arm 3 is coupled to the base 2 may be located at the center point of the upper surface 2b, although any of a plurality of locations are contemplated (e.g., proximate an edge of the upper surface 2b). In various embodiments, the base joint 7 between the base 2 and the support arm 3 may be detachable, and may have a configuration similar to detachable joint 4 (described in greater detail herein and illustrated in FIG. 8). For example, the base joint 7 may be configured to provide an electrical connection between the base 2 (e.g., one or more electrical components in the base) and the support arm 3 (e.g., one or more electrical components in the support arm). However, in various embodiments, the base joint 7 may not be detachable, such that the support arm 3 is securely fastened to the base 2 to inhibit decoupling of the various components.

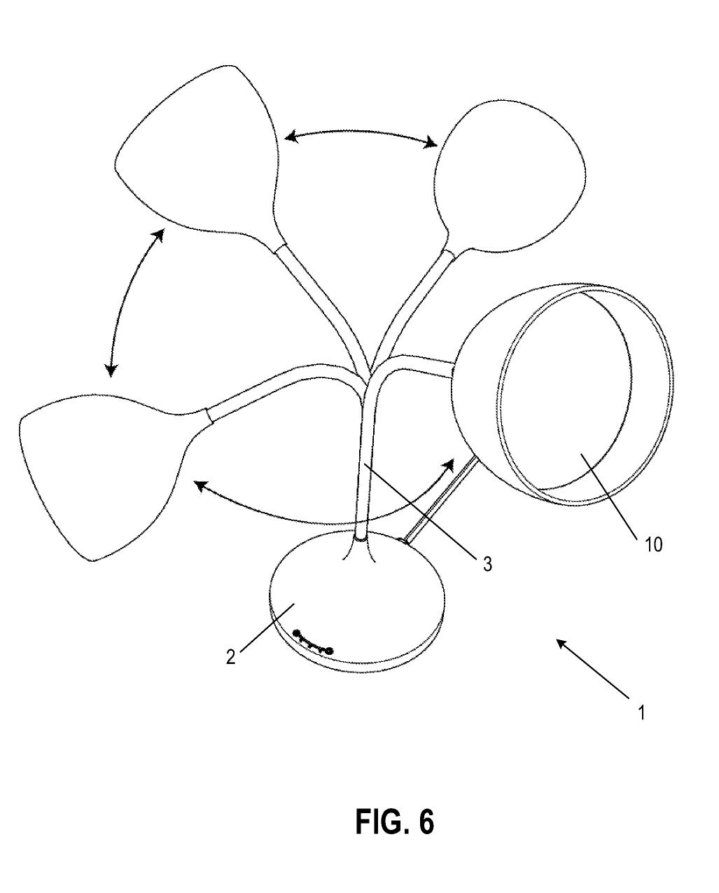

In various embodiments, the support arm 3 may comprise a metal or plastic material, and may be configured to be reconfigured to take various shapes. Thus, the support arm 3 may comprise a flexible material configured to allow a user to position it in a desired position (e.g., between a curved configuration as shown in FIG. 1A and a straight configuration as shown in FIG. 1B, or in any of a variety of radial positions, as shown in FIG. 6, which illustrates the support arm 3 of a stand lamp 1 positioned in a variety of alternative positions), and thereafter maintain the desired position. Such flexible material may enable the support arm 3 to be infinitely flexible in any direction and at any point along the length of the support arm 3, such that it may be flexed at substantially any location along its length and in any direction. The support arm may be sized such that the stand lamp 1 may be suitable as a table lamp, a floor lamp, an adjustable wall-mounted lamp (e.g., a wall sconce), an adjustable ceiling mounted lamp, and/or the like. For example, the support arm 3 may be between 12″ and 36″ in length for use as a table lamp or may be between 48″ and 84″ in length for a floor lamp. However, it should be understood that the support arm 3 may have any length suitable for a desired application. In various embodiments in which the base joint 7 is detachable, the support arm 3 may be replaceable such that the stand lamp 1 may be configurable between, for example, a table lamp and a floor lamp. Moreover, the support arm 3 may comprise a lower end configured to be coupled to the base 2 and an upper end configured to be coupled to a removable lamp assembly. In various embodiments, the support arm 3 may cylindrical in shape, having a hollow interior such that electrical wires (e.g., electrical conductors coated in an insulating material) may be routed through the support arm 3 between the base 2 and an upper portion of the support arm 3. However, the support arm 3 may have any of a variety of cross-sectional shapes. Moreover, in various embodiments, the support arm 3 may comprise a solid (or braided) core insulated from the exterior of the support arm 3 configured to conduct electricity along the length of the support arm 3. In yet other embodiments, the support arm 3 may define the insulation of the electrical conductor, such that the electrical conductor may be uninsulated within the interior of the support arm 3.

In embodiments in which the base joint 7 is detachable, the conductor (e.g., a conductor coated in an insulating material) may electrically connect the connector of the base joint 7 defined on the lower end of the support arm 3 and the connector of the detachable joint 4 defined on the upper end of the support arm 3, while the conductor remains insulated from the exterior of the support arm 3.

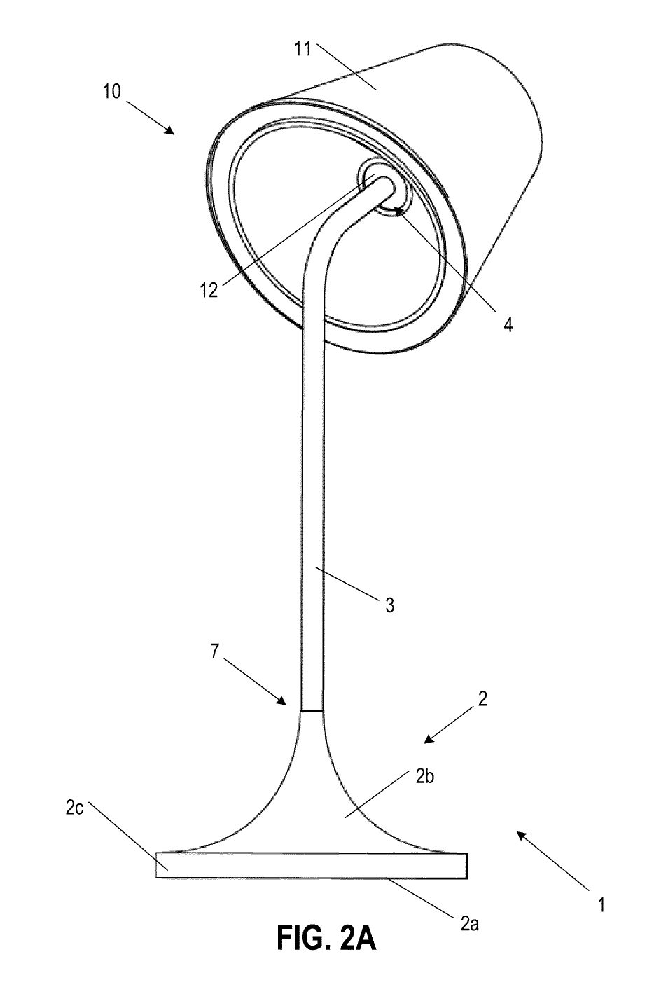

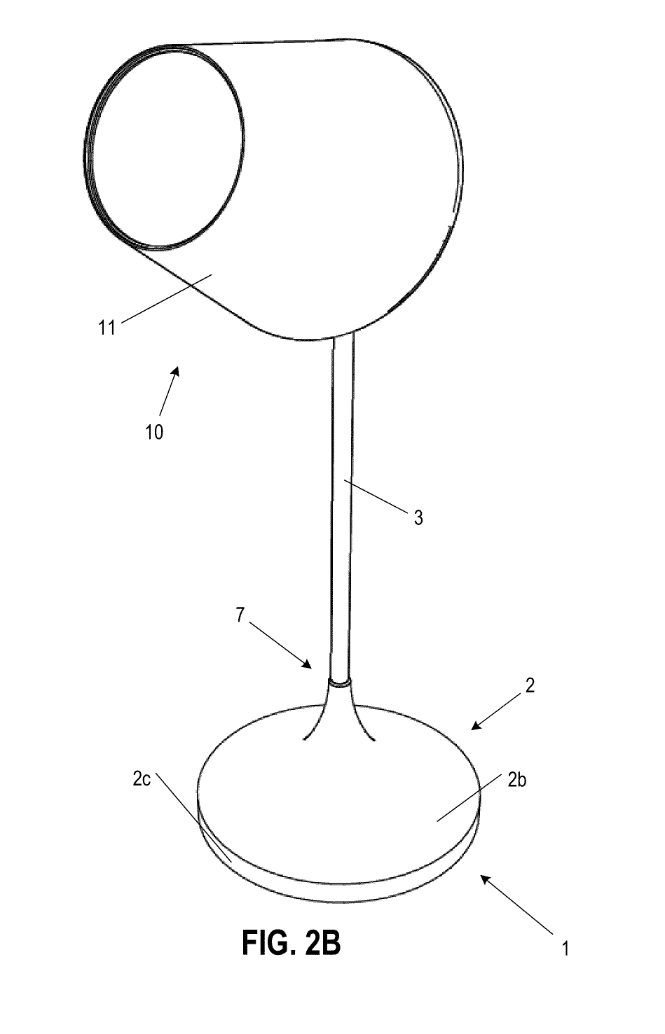

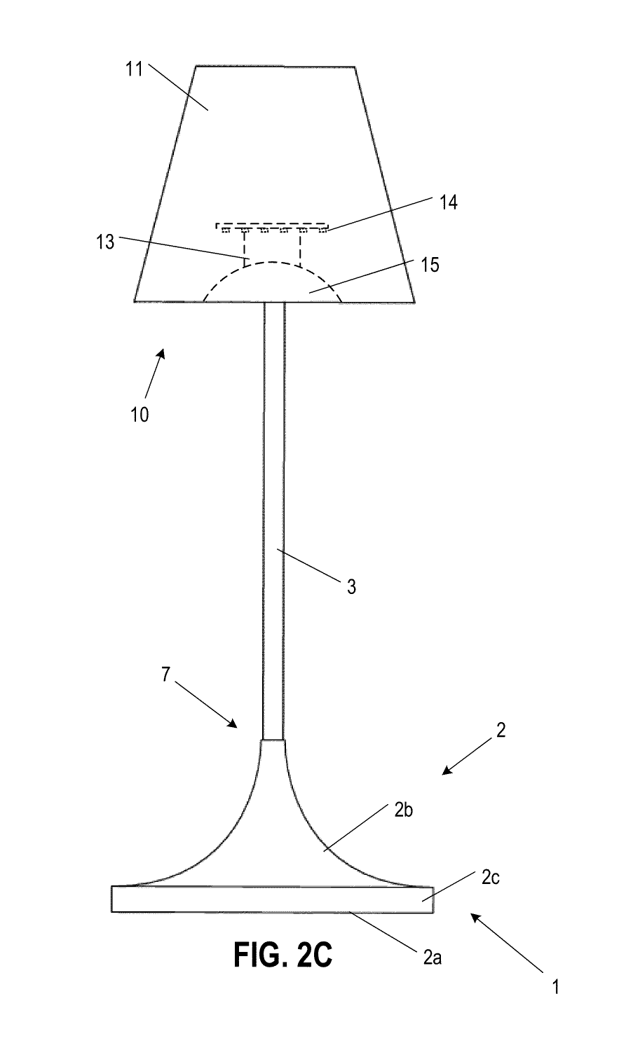

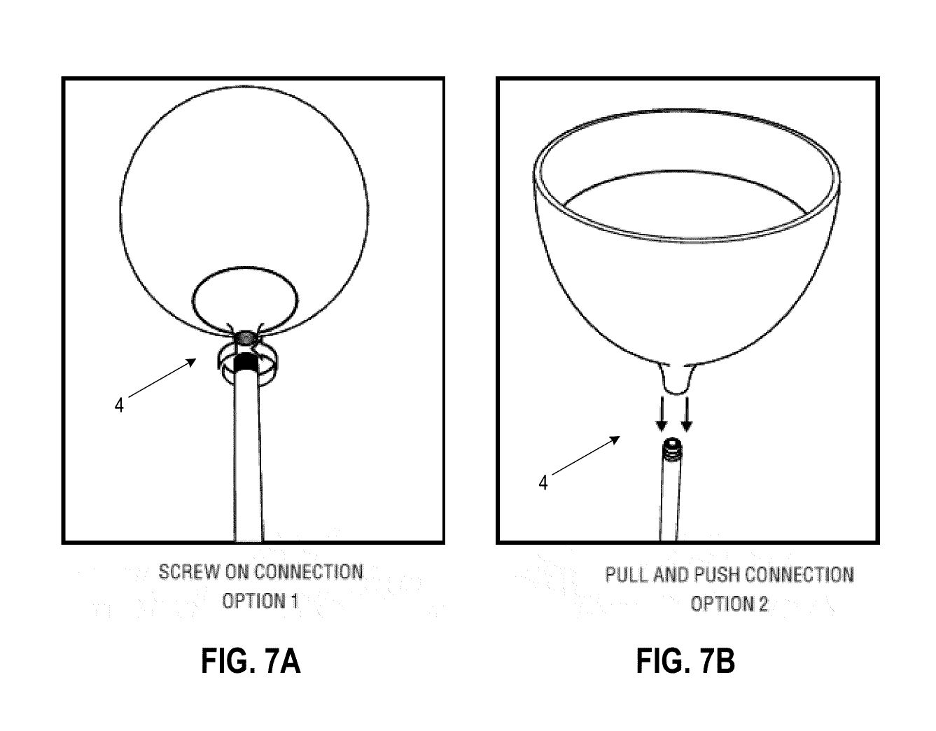

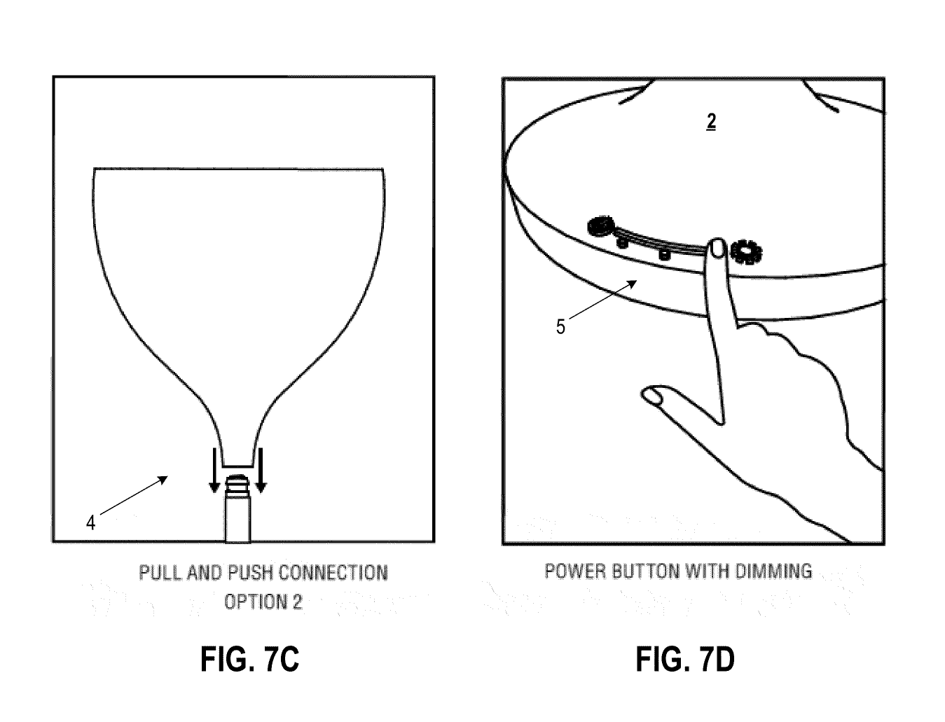

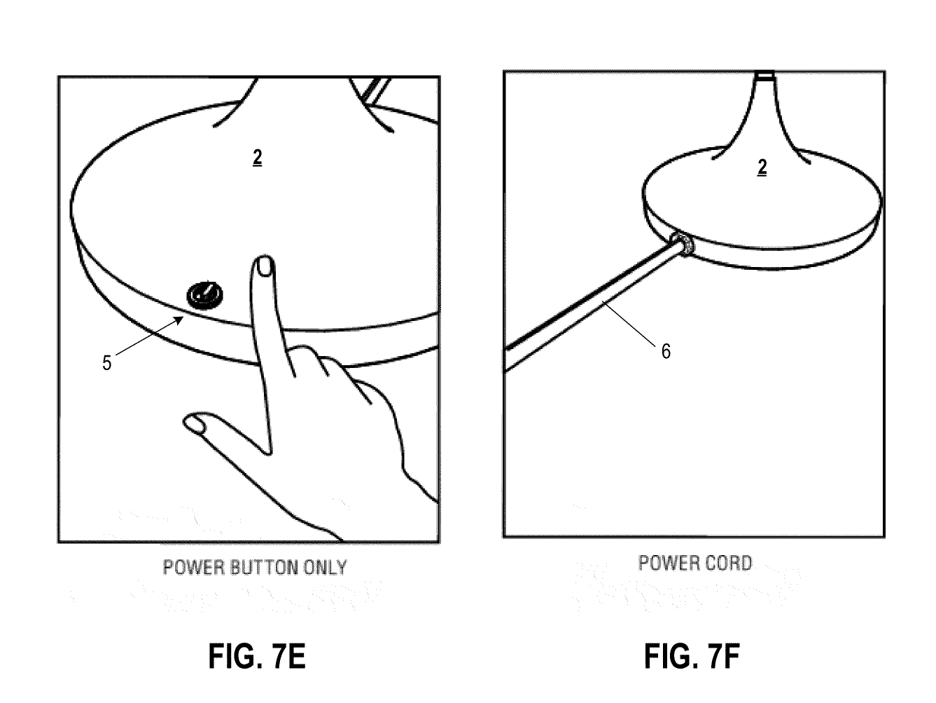

The upper portion of the support arm 3 may take the form of a first portion of a detachable joint 4 configured to be detachably coupled to a second portion of the detachable joint 4 secured to a removable lamp assembly 10. As will be described in greater detail in reference to FIGS. 7A-7F, the removable lamp assembly 10 may be detached from the support arm 3 such that other removable lamp assemblies (as illustrated in FIGS. 2A-5C) may be attached to the support arm 3 to form various configurations of a stand lamp 1.

Referring again to FIGS. 1A-1B, the removable lamp assembly 10 may comprise a housing 11 and a housing base 12. The housing base 12 may comprise the second portion of the detachable joint 4 described herein such that the removable lamp assembly may be detachably coupled to the support arm 3. A light source 13 may be positioned within the housing 11. For example, in the illustrated embodiment of FIG. 1B, the light source 13 may comprise one or more light emitters 14 (e.g., Light Emitting Diodes (LEDs), fluorescent lights, incandescent lights, a halogen lights and/or the like) configured to illuminate the interior of the housing 11. In various embodiments, the light source 13 may be configured such that the light emitters 14 are positioned to provide substantially uniform illumination of the interior of the housing 11. With reference to FIG. 1B, the light source 13 may comprise a plurality of LEDs positioned at various points around the perimeter of the light source 13 and configured to emit light away from the light source 13. Again, with reference to the embodiment shown in FIGS. 1A-1B, the housing 11 may thereby emit a uniform glow over the entire surface of the globe-shaped housing 11 shown in FIGS. 1A-1B.

The removable lamp assembly 10 may have any of a variety of light source 13 configurations. FIGS. 2A-5C provide additional examples of removable lamp assemblies 10, although these examples should not be construed as limiting.

For example, as shown in FIGS. 2A-2C, the housing 11 may have a frustum shape, and the light source 13 may be configured to emit light through side walls of the frustum shaped housing 11, which may be transparent or translucent. As illustrated in FIG. 2A, the light source 13 may comprise a plurality of light emitters 14 arranged around the perimeter of the light source 13 and positioned to emit light toward the base of the frustum shaped housing 11 (downward in the orientation shown in FIG. 2C, although this orientation may be changeable as the support arm 3 is moved). The light source 13 may additionally comprise a reflector portion 15 configured to redirect the light from the light emitters 14 toward the walls of the housing 11. In the illustrated embodiment of FIG. 2C, the reflector portion 15 may comprise a dome-shape, although any of a variety of shapes may be provided (e.g., frustum shaped, pyramid-shaped, and/or the like).

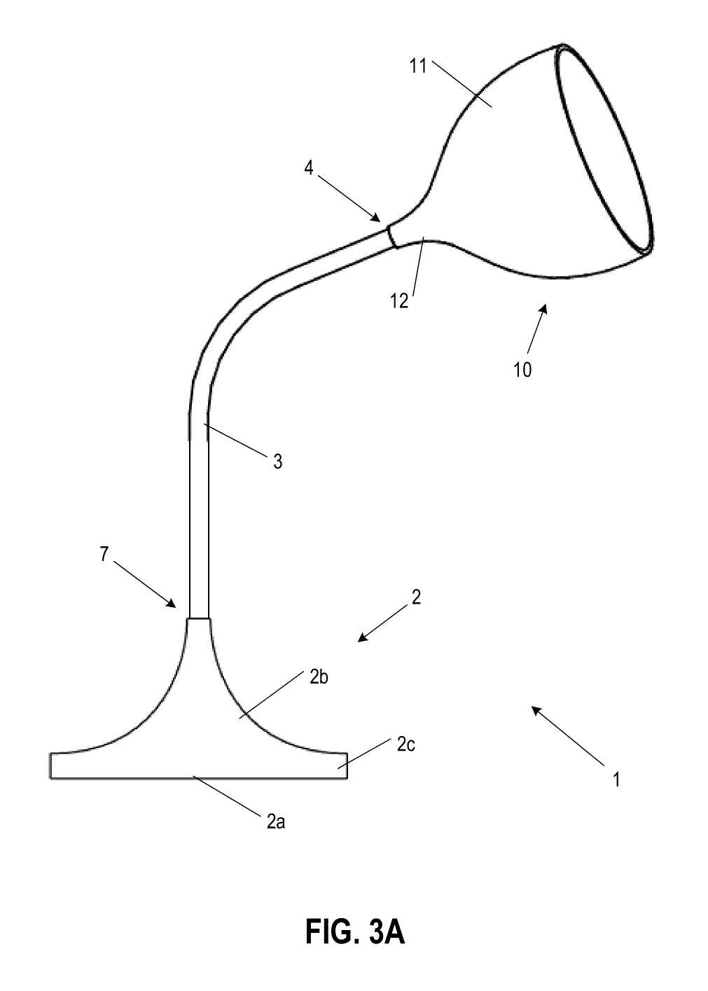

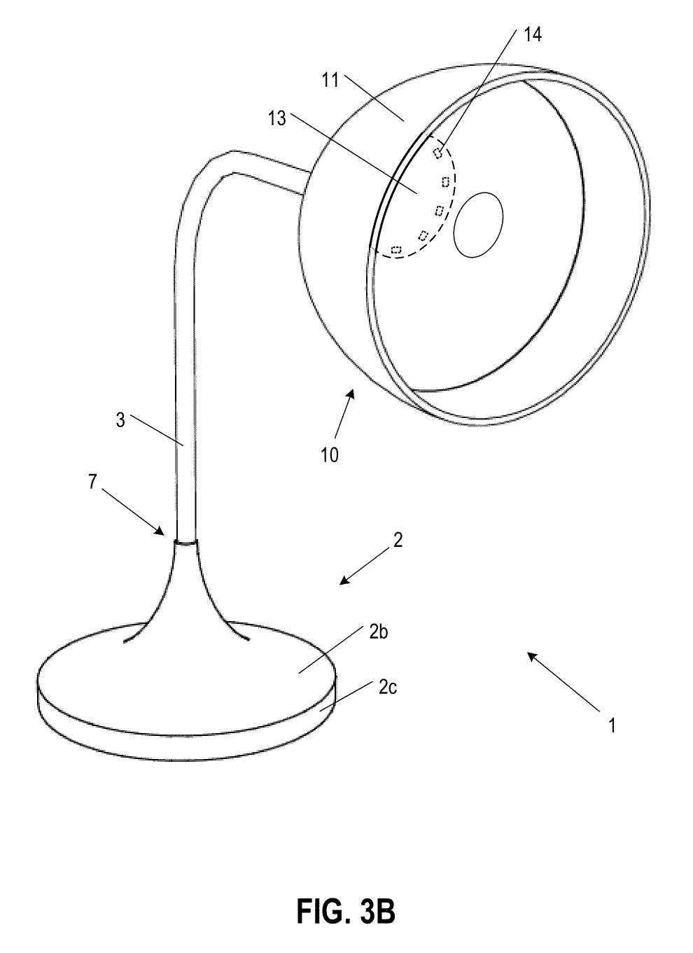

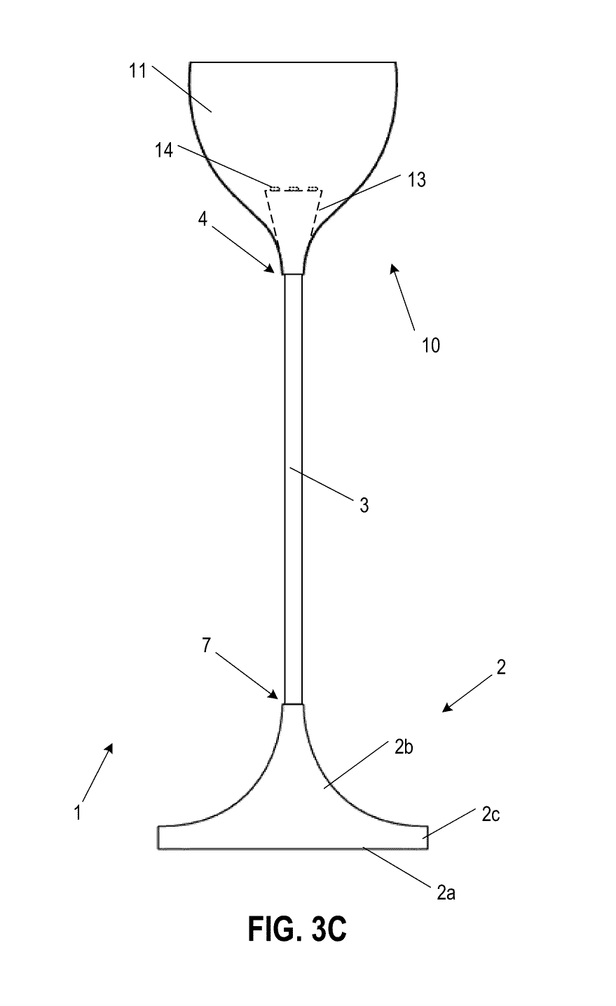

FIGS. 3A-3C provide yet another example housing 11. In the illustrated embodiment of FIGS. 3A-3C, the housing 11 may be opaque with an open end (e.g., enclosed with a translucent or transparent cover) configured to direct light from the light source 13 through the open end. However, in various embodiments, the housing 11 may be transparent and/or translucent such that light may be emitted through the walls of the housing 11. In the illustrated embodiment of FIGS. 3A-3C, the light source 13 may comprise a plurality of light emitters 14 positioned to emit light toward an open end of the housing 11. In various embodiments, the interior of the housing 11 may define a deflector, such that light directed toward the walls of the housing 11 may be redirected toward the open end of the housing 11. As noted above, the walls of the housing 11 may alternatively be transparent and/or translucent, and in such embodiments light directed toward the walls of the housing 11 may be permitted to pass therethrough.

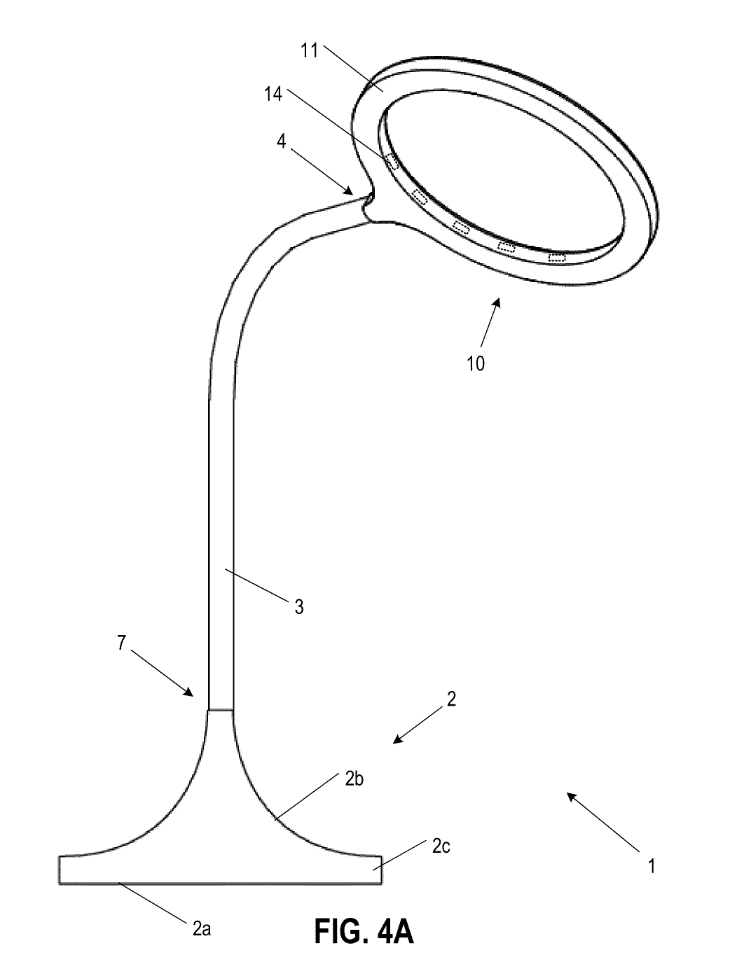

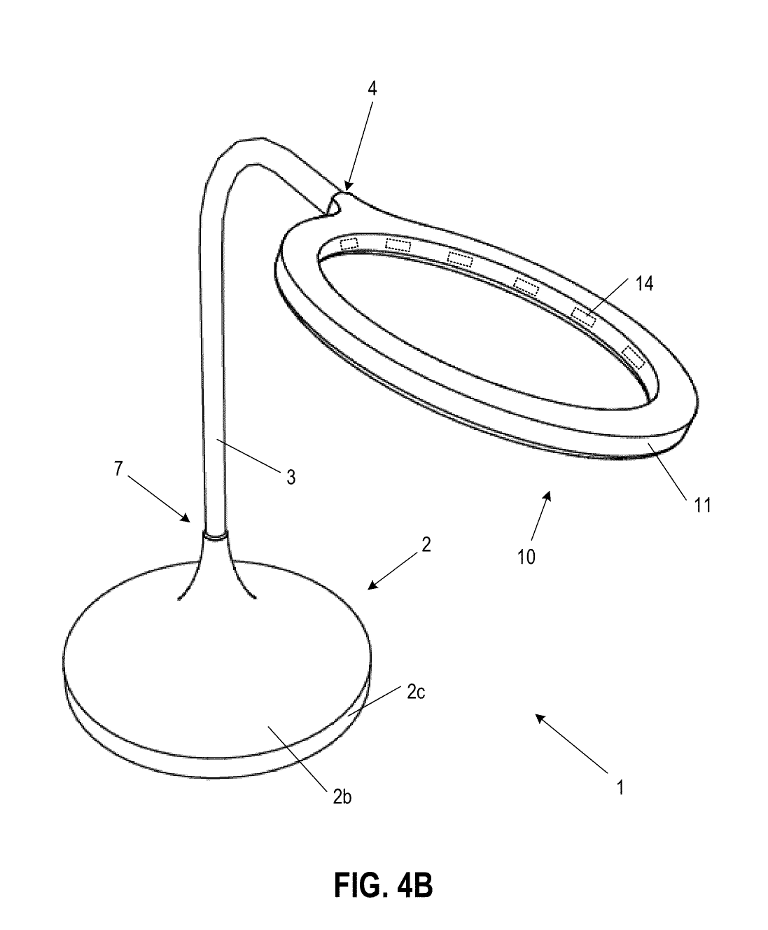

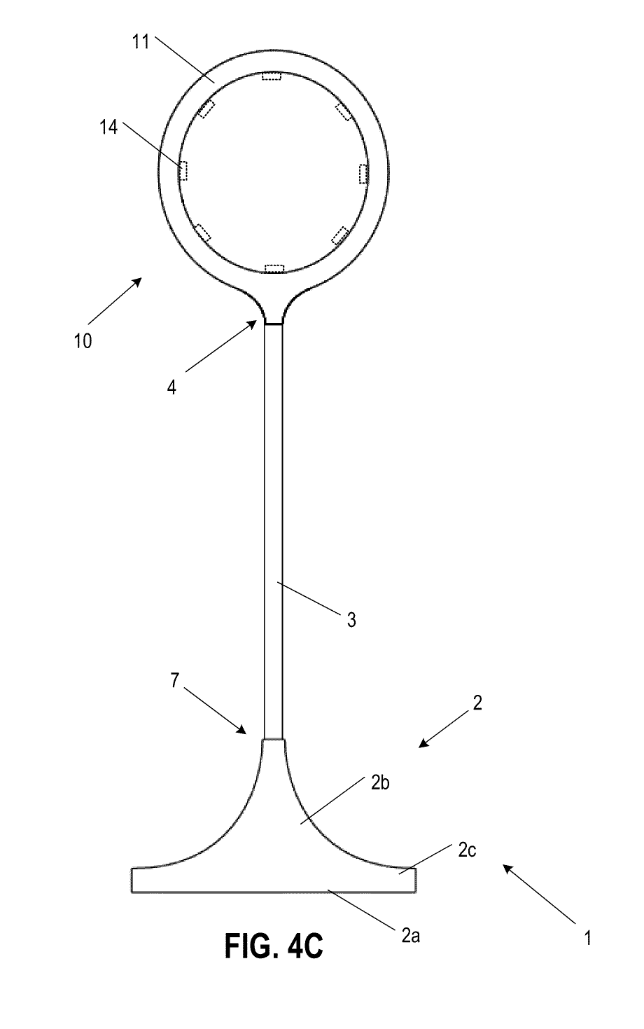

FIGS. 4A-4C illustrate yet another embodiment of a removable lamp assembly 10. In the illustrated embodiment of FIGS. 4A-4C, the housing 11 may comprise a plurality of light emitters 14 arranged around an interior perimeter of an opening extending through the housing 11. In such embodiments, the light emitters 14 may be configured to direct light away from the housing 11 in a first direction substantially parallel with a centerline extending through the opening. In various embodiments, the opening may comprise a lens, such a magnifying lens. As just one example use of such a configuration, a user may position a small object on a first side of the housing 11 such that light from the light emitters 14 illuminates the small object, while the user examines the small object using the magnifying lens.

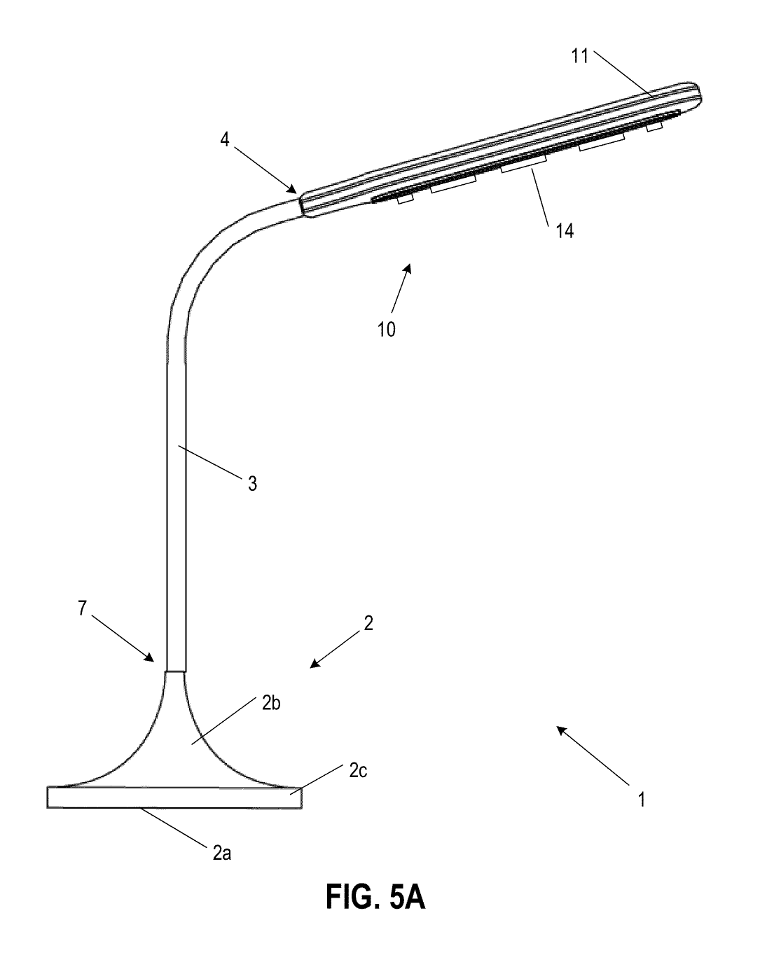

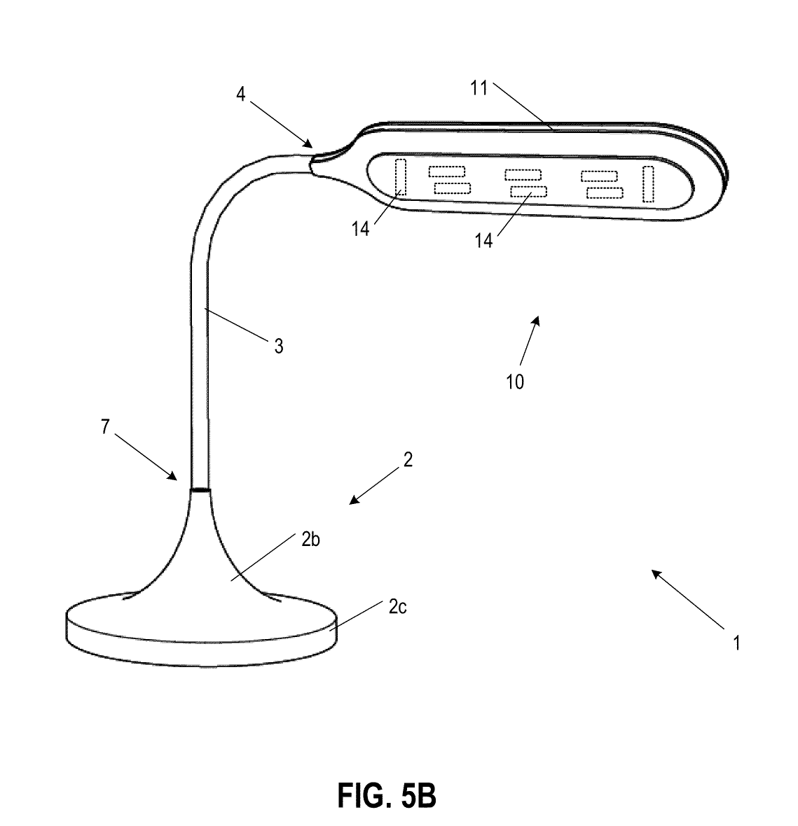

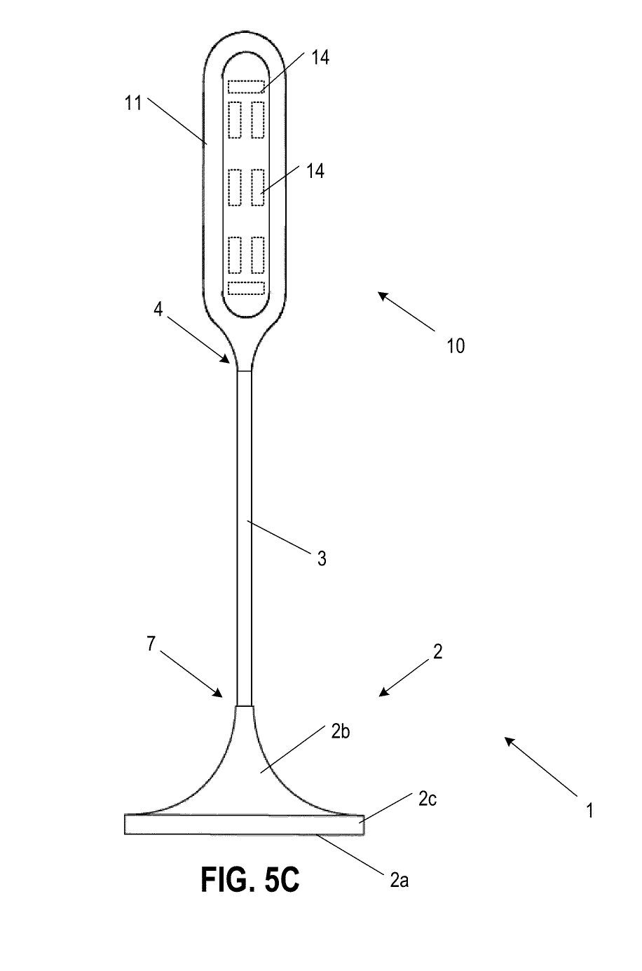

FIGS. 5A-5C illustrate yet another example removable lamp assembly 10. As shown in FIGS. 5A-5C, the housing 11 may comprise a plurality of light emitters 14 positioned to emit light away from the housing 11. In various embodiments, the light emitters 14 may be positioned on an external surface of the housing 11. In yet other embodiments, the light emitters 14 may be positioned behind a transparent and/or translucent surface such that the light is emitted through the transparent and/or translucent surface of the housing 11.

Accordingly, the housing 11 may be embodied as a lamp shade, a light diffuser, and/or the like configured to provide a desired lighting effect for the user. For example, the housing 10 may be configured to direct light in a desired direction, diffuse light in a plurality of directions, and/or the like. Such housings may comprise translucent, transparent, and/or opaque materials to provide a desired lighting effect. For example, the housings illustrated in FIGS. 1A-2C may comprise a translucent material such that light is diffused. As yet another alternative, the housing illustrated in FIGS. 3A-3C may comprise an opaque material and include an open end such that light is directed through the open end. As yet other alternatives, the housings illustrated in FIGS. 4A-5C may be substantially planar, having a light source 20 substantially exposed. It should be understood that the housings illustrated in FIGS. 1A-5C are merely examples, and any of a variety of housings may be incorporated into the stand lamp 1. Moreover, each of the removable lamp assemblies 10 may comprise various light sources 13 configured to provide various light effects. For example, removable lamp assemblies comprising housings such as those illustrated in FIGS. 4A-5C may comprise an array of light emitters 14 (e.g., LEDs) spread at least substantially uniformly across a surface of the housing 11. As yet other examples, the housings illustrated in FIGS. 1A-3C may be associated with a single light emitter 14 or a plurality of closely spaced light emitters 14 disposed within the housing 11.

Referring now to FIGS. 7A-7F, which illustrate various features of the stand lamp 1, the removable lamp assembly 10 may be configured to be replaceable with alternative lamp assemblies having different lighting types and/or different housing types.

Reference is now made to FIGS. 2A-2F, which illustrate various close-up views of features of the stand lamp 1 according to various embodiments. As shown in FIGS. 2A-2F, the upper portion of the support arm 3 may be configured to fit within a corresponding opening in the housing base 12 of the removable lamp assembly 10. As shown in FIGS. 2A-2C, the detachable joint 4 may be embodied as a screw-on joint (FIG. 7A) and/or a pressure on joint configured to provide a frictional fit between the components of the detachable joint 4 (FIGS. 7B-7C). In various embodiments, the detachable joint 4 may comprise male threads on the upper portion of the support arm 3 and female threads within the housing base 12 of the removable lamp assembly 10. As shown in FIGS. 7B-7C, the upper portion of the support arm 3 may comprise an indentation configured to accept a corresponding protrusion located on walls of the opening in the housing base 12.

Although illustrated such that the upper portion of the support arm 3 fits within a corresponding opening in the housing base 12, it should be understood that in various embodiments, the upper portion of the support arm 3 may comprise an opening configured to accept a protrusion extending away from the housing base 12. Moreover, the detachable joint 4 may comprise electrical contacts (see FIG. 8, for example, by analogy) disposed on the upper portion of the support arm 3 and the housing base 12 such that electrical power may be supplied to the removable lamp assembly 10. As a non-limiting example, the upper portion of the support arm 3 and at least a portion of the housing base 12 may comprise an electrically conductive material, such that an electrical current may flow through the detachable joint when a removable lamp assembly 10 is coupled to the support arm 3. As a non-limiting example with reference to FIG. 7A, the threaded portion of the support arm 3 and the threaded portion of the housing base 12 may each comprise an electrically conductive material, such that when the detachable joint 4 is assembled, an electrically conductive connection is formed.

Referring now to FIGS. 7D-7E, the stand lamp 1 may comprise a user interface 5 configured to accept user input. For example, the user interface 5 may comprise one or more buttons, knobs, switches, capacitive switches, touch-sensitive switches, and/or the like configured to accept user input. As shown in FIG. 7D, the user interface may comprise a power control configured to control whether electrical current is provided to the removable lamp assembly 10 and a dimmer control configured to accept a user input regarding a level of lamp brightness desired by the user. As shown in FIG. 7E, the user interface may only comprise a power control. However, various additional user interface features may additionally be included in various embodiments. Although the user interface 5 is illustrated as being incorporated into the base 2, it should be understood that the user interface 5 may be provided in any of a variety of locations (e.g., on the support arm 3 on the removable lamp assembly 10, and/or the like).

Referring now the FIG. 7F, the stand lamp 1 may additionally comprise a power cord 6 configured to connect the stand lamp 1 to an external power source (not shown), such as an Alternating Current (AC) power source. In various embodiments, the power cord 6 may be detachably coupled to the stand lamp 1, or it may be securely coupled thereto such that the power cord 6 cannot be detached from the stand lamp 1. Although not shown, the stand lamp 1 may additional comprise a power converter configured to convert the electrical current received from an AC power source to Direct Current (DC) before providing electrical current to the removable lamp assembly 10. The power converter may be located within the base 2, or it may be located in a separate enclosure coupled to the power cord 6.

Reference is now made to FIG. 8, which illustrates a close-up view of a detachable joint 4 according to various embodiments of the present invention. As shown in FIG. 8, the detachable joint 4 may comprise a male portion 4a and a female portion 4b configured to detachably secure to the male portion 4a and thereby form an electrically conductive connection therebetween. As shown in FIG. 8, the male portion 4a may comprise an electrical contact 41a disposed on a surface of the male portion 4a. The electrical contact 41a may be configured to engage a corresponding electrical contact (not shown) disposed on an interior surface of the female portion 4a of the detachable joint 4. Thus, when the male portion 4a is inserted into the female portion 4b, the electrical contacts 41a, b are in contact to form an electrical connection therebetween.

As shown in FIG. 8, the male and female portions of the detachable joint 4 may additionally comprise engagement members 42a, 42b configured to interlock and thereby provide a secure and detachable mechanical connection therebetween. Thus, a removable lamp assembly 10 may be mechanically supported on the support arm 3 via the detachable connection 4. In various embodiments, at least one of the male portion 4a or the female portion 4b is integrated into the removable lamp assembly 10, and a corresponding portion is integrated into the flexible support arm 3. Moreover, a plurality of removable lamp assemblies 10 may comprise a detachable joint portion corresponding to the portion integrated into the flexible support arm 3 such that any of the variety of removable lamp assemblies 10 may be mechanically and electrically coupled to the support arm 3 via the detachable joint 4.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A stand lamp comprising:
a base;
an infinitely flexible support arm coupled to the base and defining an arm connection point; and
a removable lamp assembly comprising one or more light emitters and a housing, wherein the removable lamp assembly defines a housing connection point; and
wherein the housing connection point and the arm connection point are configured to be detachably coupled together to form an electrical connection therebetween.

2. The stand lamp of claim 1, wherein the one or more light emitters comprises a light emitting diode.

3. The stand lamp of claim 1, wherein the infinitely flexible support arm is sized such that the stand lamp is a floor lamp.

4. The stand lamp of claim 1, wherein the infinitely flexible support arm is sized such that the stand lamp is a table lamp.

5. The stand lamp of claim 1, wherein the stand lamp additionally comprises a user interface.

6. The stand lamp of claim 5, wherein the user interface comprises a power control.

7. The stand lamp of claim 5, wherein the user interface comprises a dimmer control.

8. The stand lamp of claim 5, wherein the user interface comprises a touch-sensitive switch.

9. The stand lamp of claim 1, wherein the housing comprises a lamp shade.

10. The stand lamp of claim 1, wherein the housing comprises a diffuser.

11. The stand lamp of claim 1, wherein the stand lamp further comprises a second removable lamp assembly, the second removable lamp assembly comprising one or more light emitters, a second housing, and a second housing connection point, wherein the second housing connection point is configured to be coupled to the arm connection point to form an electrical connection therebetween.

12. The stand lamp of claim 1, wherein the support arm defines a hollow conduit therein, and wherein the stand lamp additionally comprises a conductor positioned within the hollow conduit of the support arm electrically connecting the base and the arm connection point.

13. The stand lamp of claim 1, wherein the arm connection point and the housing connection point define corresponding threads configured to interlock to detachably secure the arm connection point and the housing connection point.

14. The stand lamp of claim 1, wherein the arm connection point and the housing connection point are configured to be frictionally engaged to detachably secure the arm connection point and the housing connection point.
